(19) United States
(12) Patent Application Publication
(10) Pub. No.: US 2006/0114146 A1
(43) Pub. Date: Jun. 1, 2006

(54) Multi-targeting method and multi-targeting sensor device for locating short-range target objects in terms of distance and angle

(75) Inventors: Stefan Lindenmeier, Elchingen (DE); Johann-Friedrich Luy, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/538,731

(22) PCT Filed: Dec. 2, 2003
(86) PCT No.: PCT/EP03/13546

§ 371 Date: Jun. 13, 2005

(30) Foreign Application Priority Data
Dec. 12, 2002 (DE) 102 58 367.6

(51) Int. Cl. G01S 13/08

(52) U.S. Cl. 342/125; 342/70; 342/126; 342/133; 342/139; 342/146

(57) ABSTRACT

A multi-targeting method for locating short-range target objects in terms of distance and angle. The method includes the following steps: a) a characteristic signal is emitted by a transmitting antenna of a first sensor element; b) the reflected characteristic signal is received by at least two adjacent reception antennae of the first sensor element; c) the difference in transit time of the reflected characteristic signal to the two adjacent reception antenna of the first sensor element is measured in order to determine the distance between the target objects and the first sensor element; and d) the phase differences of the characteristic signal between the two adjacent reception antenna of the first sensor element are measured in order to determine the angles between the target objects and the first sensor element. In addition, a device for implementing the above-mentioned method.

### TECHNICAL AREA OF THE INVENTION

The present invention relates in general to a multitarget-capable method and a multitarget-capable sensor device for distance and angle positioning of close-range target objects. More specifically, the present invention relates to a multitarget-capable radar sensor device for distance and angle positioning of close-range target objects and a method for operating such a multitarget-capable radar sensor device.

### BACKGROUND INFORMATION

The position of target objects located at a great distance compared to the dimensions of a measuring device may be determined using conventional radar technology among other things. The distance and direction (angle) of a target object to be detected must be determined in this case. A narrow beam lobe of a radar is panned to determine the direction. Antennas or antenna groups having a high directional effect, whose dimensions are multiples of the radar's wavelength, are needed to generate the narrow beam lobe.

The above-described radar is disadvantageous in that it is relatively expensive and requires considerable space due to the large antenna apertures.

As an alternative, radar sensors delivering angle measurements via triangulation to determine the position of a target object have been developed in the related art.

However, considerably more than two sensor elements located at different distances must be used to prevent ghost targets and obtain unambiguous angle measurements. Ghost targets mean that after detecting the distances of multiple targets using multiple sensor elements there are multiple possible ways of combining the individual distance values to determine the position of the target objects.

FIG. 1 shows such a problem of ghost target detection, where the ambiguous evaluation of the distance information available from the sensor elements is shown for the case where two sensor elements 1 and 2 are used. The ghost targets are located at the points of intersection of the arcs of circle drawn through the particular target objects to be detected from sensor elements 1 and 2 (as centers). The number of target objects is thus doubled according to the example of FIG. 1.

In addition, it has been found disadvantageous in triangulation that the angular resolution is extremely inaccurate in the case of large distances of the target objects compared to the distance of the sensor elements.

### SUMMARY OF THE INVENTION

The object of the present invention is therefore to avoid the disadvantages of triangulation and provide a multitarget-capable method and a multitarget-capable sensor device for distance and angle positioning of close-range target objects where there is no risk of ghost target detection.

This object and other objects recited in the description that follows are achieved via a multitarget-capable method and a multitarget-capable sensor device for distance and angle positioning of close-range target objects according to the appended claims.

The multitarget-capable radar according to the present invention for providing the distance and direction of multiple target objects includes at least one sensor element which emits a characteristic signal (e.g., FMCW, pulse, or pseudo-noise), the characteristic signal being evaluated, after reflection on the target objects to be positioned, by two or more receivers whose antennas are adjacent to one another. The distance between the antennas is preferably in the range of the sensor elements' wavelengths. In the evaluation, the distances to the target objects are obtained conventionally, it being possible to unambiguously assign only one phase difference between the signals received by the receivers, corresponding to the direction of the target objects, to each measured target object distance. Each sensor element of this type is therefore multitarget-capable despite the small antenna group of two or more antennas, as long as only one target object is contained in each distance range.

According to a further particularly preferred aspect of the present invention, two or more sensor elements according to the present invention located at a distance from one another which is greater than the distance resolution of the sensor elements may be used to obtain unambiguous angle measurements for all target objects without exception. The sensor device is thus completely multitarget-capable, because the limitation that each target object has a different distance to the sensor element always applies to two sensor elements. Only few sensor elements are needed, which have a simple design, because mechanical panning, large-aperture antennas, or many receivers are not needed.

According to a further aspect of the present invention, when multiple sensor elements are used, all signal paths between their transmitters and receivers may be used, whereby a plurality of reflection points represents the target object contours. This advantageously makes it possible to recognize not only the direction and distance, but also the spatial shape of target objects.

In a further embodiment of the present invention, the beam lobes of the transmitter antennas may also be panned to further increase unambiguity. In this case different antenna lobes may be used consecutively for transmission and reception. For example, a maximum and a zero position may be directed alternately onto the target objects.

### BRIEF DESCRIPTION OF THE DRAWING

Further features and advantages of the present invention, as well as the design and mode of operation of different embodiments of the present invention are described below with reference to the appended drawing. The appended drawing illustrates the present invention and, together with the description, elucidates the principles of the invention, allowing those skilled in the art to implement and use the present invention.

FIG. 1 shows the problem of ghost target detection in a method of the related art using triangulation for detecting the direction of a target object;

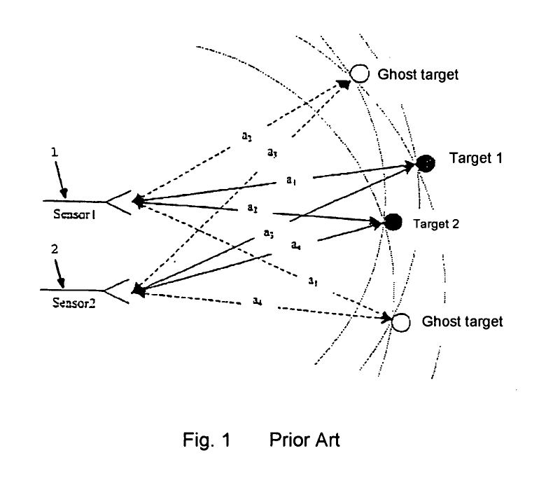

FIG. 2 shows a sensor element for determining, according to the present invention, the angle of incidence in the case of a single target object;

FIG. 3 shows the superposition of the waves from two different directions in a sensor element of FIG. 2;

FIG. 4A shows a sensor element according to the present invention having a pulse generator for determining the angle of incidence in the case of one target object or a plurality of target objects;

FIG. 4B shows a sensor element according to the present invention having a PN generator for determining the angle of incidence in the case of one target object or a plurality of target objects;

FIG. 4C shows a signal response function (e.g., pulse response) plotted against the distance, the maxima of the signal response function being located at the points of the target object distances;

FIG. 5 shows an additional embodiment of the present invention having a system of three sensor elements for recognizing an elongated object and a punctiform object;

FIG. 6 shows another embodiment of the present invention having a plurality of sensor elements mounted on a vehicle, which are operated in transmission multiplex mode according to Table 1;

FIG. 7 shows the measurement of the angle to one or more target objects, a transmission lobe having a maximum in the panning angle direction being panned, and the lobe of the receiving antenna being omnidirectional;

FIG. 8 shows the measurement of the angle to one or more target objects, a split transmission lobe having a minimum in the panning angle direction being panned, and the lobe of the receiving antenna being omnidirectional;

FIG. 9 shows the measurement of the angle to one or more target objects, a transmission lobe having a maximum in the panning angle direction being panned, and the lobe of the receiving antenna also being panned stepwise; and

FIG. 10 shows the measurement of the angle to one or more target objects, a split transmission lobe having a minimum in the panning angle direction being panned, and the split lobe of the receiving antenna also being panned stepwise.

### DETAILED DESCRIPTION OF THE PREFERRED EMBODIMENTS

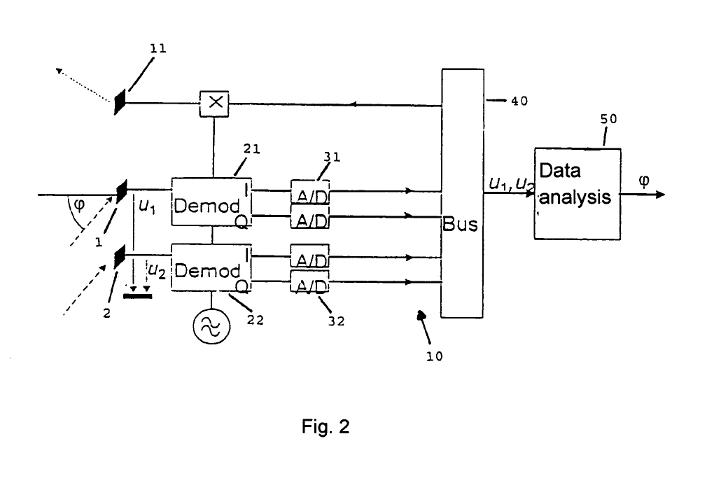

With reference to FIG. 2, a sensor element 10 for determining, according to the present invention, angle of incidence ø (direction) is shown in the case of a single target object (not shown). Sensor element 10 has a transmitting antenna II and at least two receiving antennas 1 and 2. Each of receiving antennas 1 and 2 is connected to a quadrature detector 21, 22, which demodulates the particular signals U₁ and U₂ of the receiving antennas into in-phase (I) and quadrature (Q) signals. Subsequently, the demodulated signals are subjected to an A/D conversion in the particular converters 31 and 31 and supplied, over bus 40, to processing unit 50, where angle of incidence ø of the wave reflected on the single target object is computed using the phase difference between the receiving antennas on the basis of the following formula:

$$sin φ = \frac{2}{π} arctan ( j \frac{{\underline{u}}_{1} - {\underline{u}}_{2}}{{\underline{u}}_{1} + {\underline{u}}_{2}} )$$

Further details for demodulation using a quadrature detector are known to those skilled in the art and described in U.S. Pat. No. 6,184,830 (Owens) or U.S. Pat. No. 5,541,608 (Murphy), and are not repeated here.

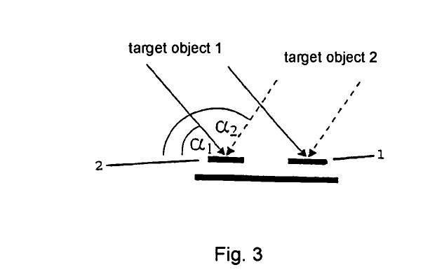

If a plurality of target objects is to be detected, it is no longer possible to make an unambiguous angle measurement using only two receiving antennas according to the above-described principle and the above formula. FIG. 3 shows this problem, illustrating the superposition of the waves from two different directions at a single sensor element designed according to FIG. 2.

From the superposition of the waves reflected from target objects 1 and 2, an angle computed from the mean of the weighted angles of incidence α₁, and α₂ results from the phase difference between the adjacent receiving antennas. It is no longer possible to determine these angles of incidence α₁ and α₂ individually from this information. An additional receiving antenna is needed for resolving these angles of incidence separately. The number of resolvable angle ranges, i.e., the angular resolution, is determined by the number of receiving antennas. Therefore, for a multitarget-capable radar system a group antenna having a very narrow pannable lobe must be used if a mechanically pannable antenna is to be avoided. The aperture of the group antenna is therefore large compared to the wavelength and the circuit is consequently more expensive, because a dedicated receiver or an RF switch is needed for each receiving antenna.

In the system according to the present invention, the direction of the target objects is determined by additionally measuring the differences in propagation time between the adjacent receiving antennas in small antenna arrays.

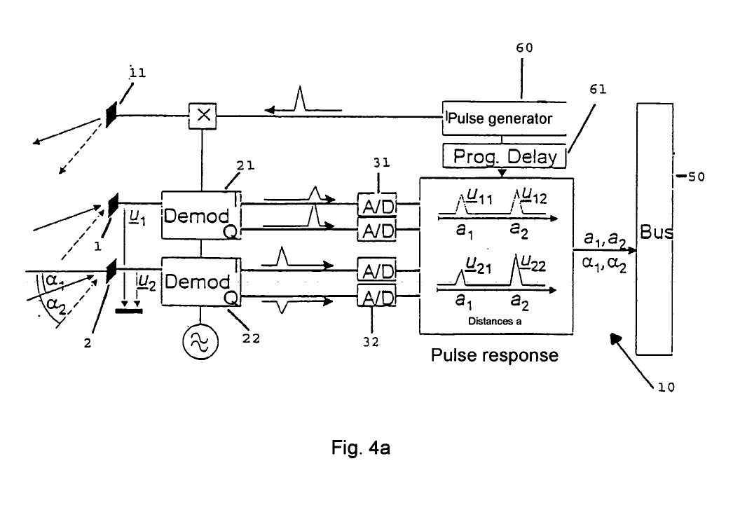

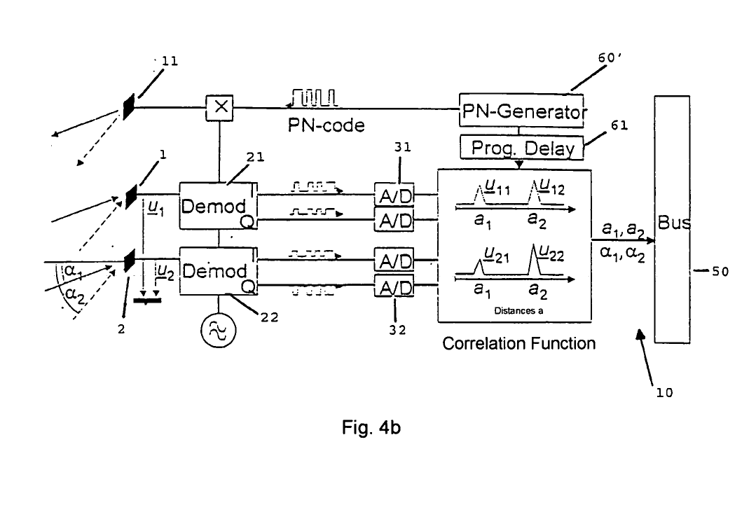

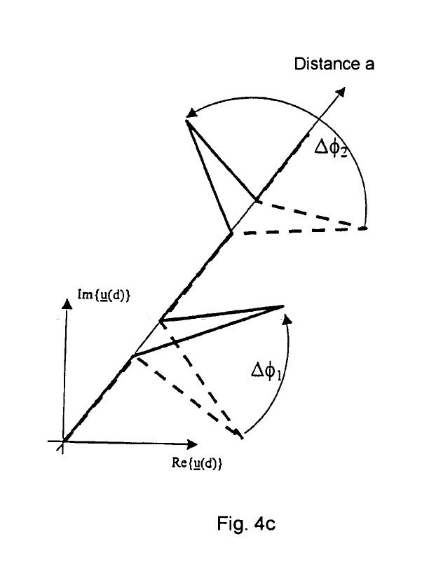

As shown in FIGS. 4A and 4B, which show embodiments of the present invention having a pulse generator and a PN generator, respectively, the system according to the present invention has a sensor element 10, which detects the distances of a plurality of target objects (not shown) by measuring the propagation times, and detects the phase difference between two adjacent receiving antennas 1 and 2 separately for each detected distance α₁, and α₂; an associated angle α₁, and α₂ is then computed for each distance from the phase difference. Ambiguous angle measurements are only possible in those cases where two or more target objects have the same distance to the one sensor element.

The transmitter sends a time-variable signal to the surroundings via a pulse generator 60 or a PN generator 60′ via transmitting antenna 11 and this signal is scattered back by multiple target objects. The back-scattered signal is received at receiving antennas 1 and 2 positioned preferably at a distance of half-wavelength, for example, and transported into the base band by the circuit shown, similar to the circuit of FIG. 2, by magnitude and phase. In each of the two receive paths, a complex signal response/distance function is formed, the phase of the complex function values corresponding to the phase of the received signal. Thus, for example, a response/distance-from-the-sensor function is obtained from the pulse response in the case of a pulse radar or from the correlation function in the case of a PN (pseudo-noise code) radar, the response/distance-from-the-sensor function having maximums at those distances from the sensor where there are reflection points, i.e., target objects. The correlation preferably takes place via a predefined delay, which is provided via the particular programmable delay elements 61. The phase of the signal back-scattered by the particular target object may be read at each of the maximums, because the phase has been transported through into the base band. By comparing the response functions generated in the two receive paths, phase difference Δφ of the signal back-scattered by each target object may be determined for this target object, i.e., for the corresponding maximum. This phase difference also exists between the receiving antennas. FIG. 4C, which shows the signal response functions plotted against the distance using the pulse response as an example, shows the maximums at which phase differences Δφ₁ and Δφ₂ of the reflected signals of target objects 1 and 2 are determined. As explained previously, the maximums are located at the point of the target object distances. The response function on the first receive path to and from the first target object is illustrated using a solid line. The response function on the second receive path to and from the second target object is illustrated using a dashed line.

A conclusion concerning the particular angle of incidence α₁ and α₂ may now be drawn separately for each target object from the phase difference between the signals at the two receiving antennas by the principle of retrodirective arrays.

For example, if a target object is at angle α₁ and a second target object is at angle α₂ to adjacent receiving antennas 1 and 2, angles of incidence α₁ and α₂ of the wave reflected by the target object may be computed from the phase difference between the receiving antennas using the corresponding formulas:

As FIG. 4C shows, among other things, the maximums coincide in the case of two target objects located at the same or approximately the same distance from the one sensor element, so that no unambiguous detection of angles of incidence α₁ und α₂ is possible.

According to the present invention, in this case the use of two or more sensor elements installed at different locations is proposed. This then produces the unambiguity, because two or more target objects which have the same distance to one of the sensor elements must have a different distance to the other sensor element(s).

$$sin {α}_{1} = \frac{2}{π} arctan ( j \frac{{\underline{u}}_{11} - {\underline{u}}_{21}}{{\underline{u}}_{11} + {\underline{u}}_{21}} )$$

$$sin {α}_{2} = \frac{2}{π} arctan ( j \frac{{\underline{u}}_{12} - {\underline{u}}_{22}}{{\underline{u}}_{12} + {\underline{u}}_{22}} )$$

Therefore, if the angle of two target objects cannot be detected by one sensor element because the target objects are located in the same distance cell, it is possible to determine the position of the target objects in each of the additional sensor elements, because the target objects are located in different distance cells with respect to those sensor elements. In principle, two sensor elements are sufficient to position all target objects in this way. Further sensor elements may, however, be used to increase the accuracy and the range of unambiguity, also advantageously providing assurance in the case where there is no or insufficient reception at one of the sensor elements.

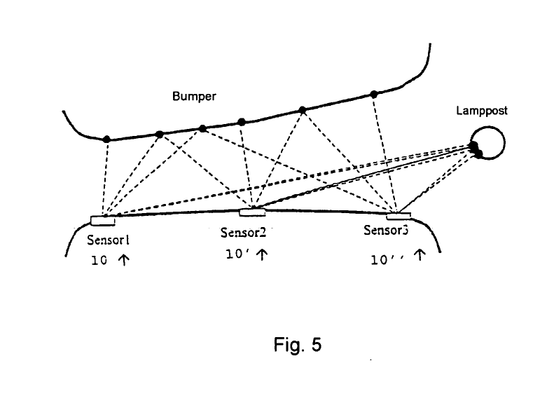

FIG. 5 shows the recognition of the contour line of an elongated target object (e.g., bumper) and a “punctiform” target object (e.g., lamppost) using three networked sensor elements 10, 10′, and 10″.

Angle recognition in each sensor element 10, 10′, and 10″ is necessary to obtain an unambiguous determination of the position of the scattering points and takes place in a manner similar to the previously described embodiments of the present invention. The use of multiple sensor elements 10, 10′, and 10″ at different points results in no erroneous angle information being obtained when multiple scattering points have the same distance to a sensor element. In addition, at least a number of scatter points equal to the number of sensor elements is detectable on elongated target objects (such as bumpers, for example). The networking of all sensor elements over their wireless paths results in at least a number of scatter points equal to the number of possible pair combinations among all sensor elements being detected on elongated target objects (such as bumpers, for example), as shown in FIG. 5. A further target object such as a lamppost, for example, may also be simultaneously detected by the sensors.

The measurement results of the networked sensor elements are analyzed via suitable programming of the processing unit, which contains the phase and distance information of each of the sensor elements, and, for example, in the case of ambiguity (no distance between the detected maximums) the unanalyzable information is filtered out and only the information of the sensor elements having a favorable position is analyzed.

In the embodiment of FIG. 5 having a plurality of sensor elements, these sensor elements, in the form of PN code sensors, may transmit and receive simultaneously past one another, or in time multiplex as described as an example in Table 1.

TABLE 1

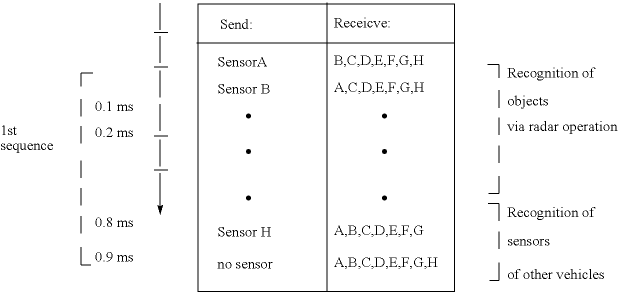

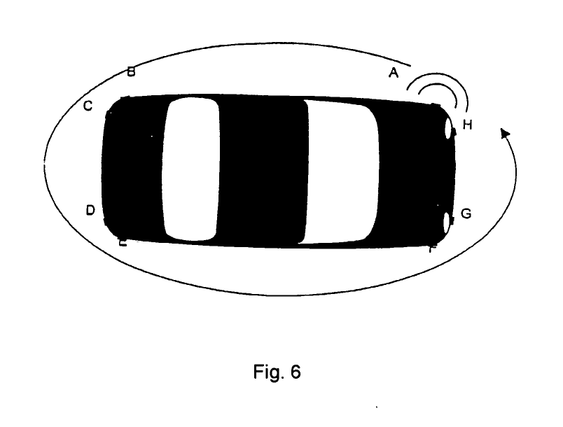

In one embodiment of the present invention, shown in FIG. 6, sensor elements A through H of Table 1, operated in time multiplex, may be mounted on a vehicle to cover all relevant detection directions.

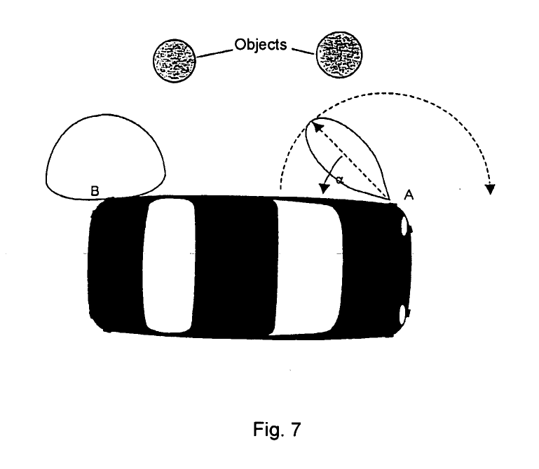

An additional embodiment of the angle recognition using small antenna groups is now described with reference to FIGS. 7 through 10. In this embodiment, different shapes of beam panning and the principle of smart antennas applied to positioning from different points of installation are used.

There is also a small group of transmitting antennas in the direction of transmission, with each antenna or at least each subgroup being controllable separately by amplitude and phase; antenna lobes of different types may thus be generated and panned. The multitude of possible antenna lobes results in higher angular resolution of the system because multiple types of transmitting antenna lobes are panned consecutively and the receiving lobes are panned simultaneously. Four degrees of freedom may thus be used to vary the type of angle measurement:
1. Shape of the transmitting antenna's lobe (e.g., with maximum or minimum in the direction of the panning angle),
2. Shape of the receiving antenna lobe,
3. Panning angle of the transmitting antenna lobe, and
4. Panning angle of the receiving antenna lobe.

These four degrees of freedom are independent of one another. If the angle measurement is varied consecutively in all four degrees of freedom, the accuracy of the angle measurement is increased manifold compared to an angle measurement resulting from panning a single type of lobe. The existence of further synchronized sensor elements capable of transmitting simultaneously in any combination may be considered a fifth degree of freedom. The different points of installation of the sensor elements in space are therefore also used to increase the variability of the measurements.

A plurality of different angle measurements are thus obtained which overall provide much more reliable data regarding multitarget capabilities and accuracy than a single conventional angle measurement. Some exemplary configurations, which illustrate the variations of the present invention with reference to the above-mentioned four degrees of freedom, are elucidated in the example below.

Example: system featuring transmitting antenna A and receiving antenna B: With reference to FIG. 7, a wide-lobe and therefore low-resolution angle scan is first performed using an antenna lobe whose maximum is in the direction of panning angle α. To improve the resolution in this measurement, the width of the antenna lobe could be reduced only by using larger arrays. To save the expense of large arrays, the type of the measurements is varied here consecutively according to the above-mentioned four degrees of freedom.

As FIG. 7 shows, in measurement 1, a transmission lobe having a maximum in the direction of the panning angle is panned, the lobe of the receiving antenna being omnidirectional.

Transmission maximums or at least higher transmission values occur in measurement 1 for those panning angles α which are directed at target objects or scattering points on target objects.

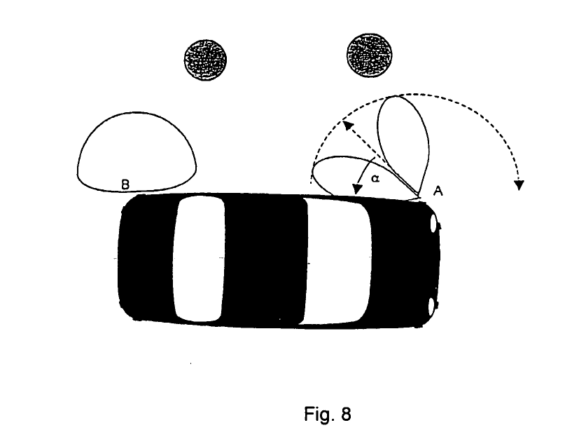

In subsequent measurement 2, a split antenna lobe is panned, as shown in FIG. 8. As expected, minimums occur at panning angles α which are directed at target objects or scattering points on target objects. Since the interference effects due to superposition of the back-scattering of other target objects are different in this measurement from those of measurement 1, the influence of the interference effects on the measurement accuracy may be reduced by processing the results of measurement 1 and measurement 2 together. A target object is thus preferably in direction a if measurement 1 shows an increased value and measurement 2 shows a minimum at the same time.

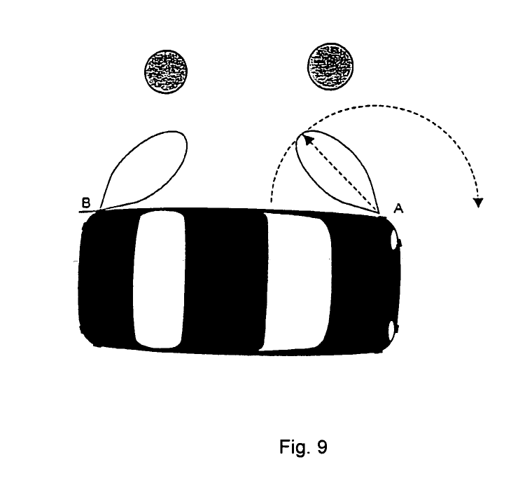

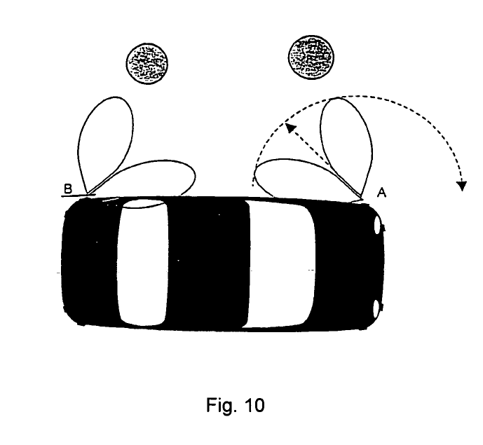

If the receiving lobe is now panned in different variations as shown in FIGS. 9 and 10, the directions of the target objects are determined with a greater accuracy from the plurality of measurement results. A transmission lobe having a maximum in the panning angle direction is thus panned, for example, in the measurement according to FIG. 9, the lobe of the receiving antenna also being panned stepwise. In FIG. 10, measurement 4 is made by panning a split transmission lobe with a minimum in the panning angle direction, the split lobe of the receiving antenna also being panned stepwise.

When features in the claims are provided with reference symbols, these reference symbols are provided only for better understanding of the claims. Therefore, such reference symbols represent no limitations of the scope of protection of such elements which are only marked with such reference symbols as examples.

1-18. (canceled)

19. A method for distance and angle positioning of a plurality of close-range target objects, the method comprising the steps of:
a) transmitting a characteristic signal using a transmitting antenna of a first sensor element;
b) receiving the characteristic signal reflected from the plurality of target objects using at least two adjacent receiving antennae of the first sensor element;
c) measuring propagation time differences of the reflected characteristic signal to the at least two adjacent receiving antennas so as to a determine respective distances of the target objects to the first sensor element; and
d) determining an angle of incidence for each of the target objects to the first sensor element, wherein the determining of the angle of incidence includes measuring phase differences of the reflected characteristic signal between the at least two adjacent receiving antennas, by subjecting each of the reflected characteristic signals received by the receiving antennae to a correlation with the transmitted characteristic signal so as to determine a complex correlation function that uniquely associates the measured phase differences with a distance, drawing a conclusion regarding the angle of incidence for each of the target objects according to the principle of retrodirective arrays.

20. The method as recited in claim 19, further comprising the steps of:
e) transmitting a second characteristic signal using a transmitting antenna of a second sensor element, the second sensor element disposed at a distance from the first sensor element;
f) receiving the reflected characteristic signal using at least two adjacent second receiving antennae of the second sensor element;
g) measuring propagation time differences of the reflected characteristic signals to the at least two adjacent second receiving antennae of the second sensor element so as to determine respective distances of the target objects to the second sensor element; and
h) measuring phase differences of the reflected characteristic signal between the two adjacent second receiving antennas to determine an angle of incidence of each of the target objects to the second sensor element.

21. The method as recited in claim 20, wherein the steps e) through h) are performed only when the propagation time differences measured in the first sensor element are approximately equal to zero.

22. The method as recited in claim 19, wherein the characteristic signal is one of a FMCW pulse signal and a pseudo-noise signal.

23. The method as recited in claim 19, wherein the further comprising a second sensor element and a third sensor element interconnected with the first sensor elements.

24. The method as recited in claim 19, further comprising varying a characteristic of the first sensor element, wherein the characteristic includes one of a shape of a lobe of the transmitting antenna, a shape of a lobe of one of the at least two receiving antennae, a panning angle of the transmitting antenna lobe, and a panning angle of the lobe of the one of the at least two receiving antennae.

25. The method as recited in claim 24, wherein the shape of the lobe having a maximum or a minimum in the direction of the panning angle is varied.

26. The method as recited in claim 20, wherein the distance between two sensor elements is greater than the distance resolution of any of the sensor elements.

27. The method as recited in claim 19, wherein measurement of the propagation time differences of the reflected characteristic signals includes detecting maximums of signal/response functions of the characteristic signal, and the measuring of the phase differences includes measuring the phase differences at the particular maximums.

28. A sensor device for distance and angle positioning of a plurality of close-range target objects, the sensor device comprising:
a first sensor element having a first transmitting antenna and at least two adjacent first receiving antennae, the first transmitting antenna being configured to transmit a characteristic signal, and the at least two first adjacent receiving antennae being configured to receive the characteristic signal reflected from the plurality of target objects;
a measuring device configured to measure propagation time differences of the reflected characteristic signal to the two adjacent first receiving antennas so as to determine respective distances of each target object to the first sensor element; and
a device configured to measure phase differences of the reflected characteristic signal between the two adjacent receiving antennae so as to determine a respective angle of each target object to the first sensor element;
a correlator configured to subject each reflected transmission signal received by the first receiving antennae to a correlation with the characteristic signal so as to determine a complex correlation function uniquely associating the obtained phase information with a distance; and
a comparer unit configured to draw a conclusion with regard to the respective angle of incidence for each target object from the phase difference between the signals at the two receiving antennae according to the principle of retrodirective arrays.

29. The sensor device as recited claim 28, further comprising;
a second sensor element disposed at a distance from the first sensor element, the second sensor element including a second transmitting antenna configured to transmit a second characteristic signal, at least two adjacent second receiving antennas configured to receive the reflected characteristic signal; and
a second measuring device to measure propagation time differences of the reflected characteristic signals between the two adjacent second receiving antennae to determine respective distances of each of the target objects to the second sensor element; and
a second device configured to measure respective phase differences of the reflected characteristic signal between the two adjacent second receiving antennas so as to determine a respective angle of incidences of each of the target objects to the second sensor element.

30. The sensor device as recited in claim 29, wherein the second device configured to measure phase differences is also configured to detect phase and propagation time differences with the aid of the second sensor element where the propagation time differences measured in the first sensor element are approximately or equal to zero.

31. The sensor device as recited in claim 28, wherein the characteristic signal includes one of an FMCW signal, a pulse signal, and a pseudo-noise signal.

32. The sensor device as recited in claim 28, further comprising a second sensor element and a third sensor element interconnected with the first sensor element.

33. The sensor device as recited in claim 28, wherein the transmitting and/or receiving antennae are designed to enable a varying of at least one characteristic, the characteristic including at least one of a shape of a lobe of the transmitting antenna a shape of a lobe of one of the receiving antenna, a panning angle of the transmitting antenna lobe, and a panning angle of one of he receiving antennae lobes.

34. The method as recited in claim 33, wherein the shape of the lobe having a maximum or a minimum in the direction of the panning angle capable of being varied.

35. The sensor device as recited in claim 29, wherein the distance between the first and second sensor elements is greater than a distance resolution of any of the sensor elements.

36. The sensor device as recited in claim 29, wherein the device configured to measure phase differences is also configured to measure propagation time differences of the reflected characteristic signals using maximums of signal/response functions of the characteristic signal, the phase differences being measured at the respective maximums.
